(19) United States
(12) Patent Application Publication
(10) Pub. No.: US 2003/0163686 A1
(43) Pub. Date: Aug. 28, 2003

(54) System and method for ad hoc management of credentials, trust relationships and trust history in computing environments

(76) Inventors: Jean Renard Ward, Arlington, MA (US); Marcel Mordechay Yung, New York, NY (US); Robert James Stewart, Sumter, RI (US)

Correspondence Address: Stuart T. F. Huang, Steptoe & Johnson LLP, 1330 Connecticut Avenue, NW, Washington, DC, 20036, US

(21) Appl. No.: 10/212,676

(22) Filed: Aug. 6, 2002

Related U.S. Application Data
(60) Provisional application No. 60/309,768, filed on Aug. 6, 2001.

(51) Int. Cl. H04L 9/00

(52) U.S. Cl. 713/156

(57) ABSTRACT

A system and method facilitates reliance among members of a community that communicates electronically. Each member has a private credential for use in a computing environment. Each member obtains the credential in accordance with a credential-issuance process. The process need not include a certification authority. Credentials may be generated directly by the members themselves. They system includes a database that contains at least one credential entry for each member . The system also includes a management process with authority to sanction (e.g., approve) reliance by the community on a member's credential. Such sanction authority is separate from the credential-issuance process. The system also includes a rule set defining a scope of reliance the community may make on a member's credential.

### BACKGROUND OF THE INVENTION

1. Field of the Invention

The field of the invention is the area of cryptographic assurance for safe and secure computing, where computing may be any activity or transaction environment that is at least partially performed over electronic computing or computing networks.

2. Discussion of Background Information

The idea of assurance using digital signing or digital identification has been developed so that remotely-located participants of a collaborative endeavor can be assured of at least the identity—and possibly also of the status and authorization—of other entities. Assurance is associated with a public key certificate or other credential for an entity's identity, authorization, characteristic, status, membership, etc. A typical certificate for a public key contains the following fields.

(i) The user (entity) ID;

(ii) The certifying authority ID;

(iii) Expiration date;

(iii) Public Key;

(iv) Signature of the certifying authority on the above fields.

A certificate may have other fields, and it may be associated with an authorization, an ID, or various other uses. The public key in the certificate has a corresponding private signing key which is to be kept private and secure and which performs the “operation” that represents the activation of the credential. This can be signing a message, a request, a challenge, etc. Cryptographic techniques for proving certain aspects of a digital certificate are known, such as verification of a digital signature.

Another PKI system is the so-called SPKI model, where a certificate is associated with an element of an Access Control List (ACL). See “Network Working Group Request for Comments: 2693, SPKI Certificate Theory,” T. Ellison et al., RFC 2693, the Internet Society, Sep. 1999 (ftp://ftp.isi.edu/in-notes/rfc2693.txt). This representation can express identity certificates, authorization (attribute) certificates and delegated certificates. Each setting will need to specifically initiate an ACL structure. The model simplifies the representation of and interface to a certificate within a system.

Other mechanisms, such as password-based authentication, challenge response by a device, or a biometrics reading, also create trust. A mix of mechanisms may exist within an environment.

A credential-holder may be an entity name, a pseudonym, a device ID or address, etc. The holder of a credential typically has some value or some unique and recognizable characteristic, such as a key, password, personal identification number (PIN) or biometric-based data that is associated with certain cryptographic capability (like signing, encrypting with a secret value, etc.). “Credential” here means a data object that includes a distinctive characteristic associated with an entity for use in authentication, authorization, or enablement in a computing activity. It may be a public key certificate that associates an entity with a secret key that is used to authenticate individuals. Other distinctive characteristics may be, among others, a password, PIN number, fingerprint, voiceprint, handwriting sample, retina scan, etc.

The process of creating a credential often involves a certification process associating the credential holder and the capability. The traditional way to certify cryptographic capability involves a trusted, third-party server that issues or registers capabilities. In most Public Key Infrastructures (PKI) designs, private keys are certified by one or more separate systems known as Certificate Authorities or CAs. These CAs perform the dual role of (a) vetting, or taking responsibility for the correctness of, and accepting the use of, a private key to establish the user of that private key as a specific individual entity, and (b) performing the technical services of generating a digitally-signed “certificate” to publicize this vetting and publishing this certificate to various directories or data archives.

Other devices may be involved in the process of certificate management. For example, certification authorities may issue certificate revocation lists and directories may provide information about certificate status. Based on static management of valid and revoked credentials, trust domains may be created where devices associated with organizations certify and manage keys within their domain.

Verisign.com, Thawte.com, and others are public, CA entities which perform both the vetting process and the technical services of digital certificates. They act as a distinct and separate third party from either a party seeking a certificate or a party relying on a certificate. “PGP” is a known PKI which has no CAs and no distinct vetting process at all. It uses self-signed, self-generated certificates.

Some third-party CAs, such as Verisign, offer low-grade vetting services, where their criterion for vetting is that some number of other low-grade vettees “vouch” for the identify of the potential vettee. However, services of the actual vetting and the technical services of digital certificates are still performed centrally by the same entity (a specific CA), and all digital certificates are generated and signed by this CA.

RSA Security also has a product, the Keon Security.

A good background reference on the art of certification and certification authorities is the book, “Applied Cryptography,” B. Schneier, John Wiley & Sons, Inc., 2nd ed., 1996. See also “Secure Electronic Commerce: Building Infrastructure for Digital Signatures & Encryption,” W. Ford and M. Baum, Prentice Hall Publishers, 2nd ed. 2000.

The management of credentials may be complicated by inter-organizational relationships. Such complexity can result from changing business relationships among commercial entities, ad hoc organizational changes, or other dynamic events which typify commercial and public life. Copending U.S. patent application entitled “A Method for Cryptographic Control and maintenance by Frankel, Montgomery, and Yung (U.S. application Ser. No. 09/503,181, filed Feb. 14, 2000) discloses a method by which an organization may present itself as external roles to the outside world as part of the externally-visible organization's PKI. At the same time, the assignments of internal entities to the outside roles' credentials are managed internally by an internal PKI that assigns individuals and groups to external roles.

### SUMMARY OF THE INVENTION

Dynamic credential management requires new mechanisms. Merely certifying and validating authorities and applying strict rules about validity of credentials are inadequate for the management of business relationships and other dynamics of organizations that are essential to business and commerce as well as other organizations and activities such as branches and bodies of government and of international organizations, private administrations, manufacturing processes, health management, finance, and so on.

The traditional PKI systems with central CAs are awkward. The central generation of digital certificates requires all holders of private keys to communicate them to the central CA, and the CA must communicate the digital certificate back to the holder of the private key. This presents both technical and procedural tasks that touch every member of the community that uses the CA. This awkwardness can be reduced by permitting use of a variety of credentials, including self-generated credentials (e.g., certificates or other data objects created by individual community members and signed by each member's own signature key). Such credentials may then be vetted by entities that are connected to the users who exchange information with the credential-generator in the normal course of other, regular business interactions.

Traditional PKI systems with central CAs are also awkward because vetting criteria, which determine whether a particular entity should be given a certificate, may vary among different groups that use the CA. CAs typically perform the vetting process centrally and uniformly, because the business processes of vetting are combined with the technical services of digital certificate issuance and revocation in one entity.

The internal need for uniformity clashes with the external need for flexibility. This awkwardness can be avoided by separating the business process of vetting from the technical services of issuance and revocation.

CA-less PKI designs, such as PGP, are awkward in large organizations, because every individual must perform all vetting decisions for all private/public keys that may be used to identify each and every holder of the private keys. This awkwardness can be avoided by maintaining a central repository for certificates and/or other credentials, which any user may contact to check the status of a certificate or credential.

Even when an external CA does vetting (and issues a certificate), another entity may wish to make a different vetting decision and define a different vetting status from that decision made by this external CA. This can be permitted by providing a separate and independent repository of certificates (and/or other credentials) and their vetting status by the first entity, which can be queried separately about the “local” vetting status of the credential.

What is needed is a flexible, dynamic and robust mechanism for managing credentials in an open, possibly inter-organizational setting. What is also needed is a management structure that enables the control of business relationships and their applications as the organizations develop and the relationships of parties in transactions change. What is additionally needed is a dynamic, flexible and ad hoc management layer in the overall system which manages the credentials.

It is a goal of this invention to provide mechanisms that are based on business and management rules inside and between organizations. It is also a goal of this invention to manage capabilities in such environments. It is another goal to permit use of a variety of types of credentials within a system and to provide new ways to control, manage and utilize a variety of credentials in a computing environment. Control and administration of a management layer are additional goals of this invention.

An example of a computing environment like the above is a commercial setting of a consortium where organizations and their representatives act in a common system. Each organization may have its own trust relationships in existence (e.g., independent certification employees by different, internal CAs that do not belong to the same hierarchy of a Public Key Infrastructure). Some functions within an organization (but not the entire organization) may need to be reorganized and maintained dynamically as the organization changes for the purpose of representing credentials inside the consortium. Organizations may join (or leave) the consortium, and the trust relationships need extensions. The maintenance of the consortium credentials should be done so that the management of credentials inside the individual organizations is not disturbed. It is another goal of this invention to provide mechanisms for doing the above. The consortium may maintain a “credential data base.” Rules for maintaining the global (possibly distributed) state of active credentials have to be determined and used by all consortium participants. Safety measures have to be provided as well.

Another example of a computing environment may be among members of an exchange which need to bring credentials and manage them. They may need to present credentials to a central authority. They may use existing trusted channels to present and maintain the credentials (or such channels may need to be provided). In any event, members must agree on “credential channels” where changes and maintenance activities of credentials take place. It is the purpose of this invention to provide for the formation of such channels with minimal required technical constraints. The channels should follow the business transactions and the business rules taking place within the exchange. The credential channels should carry signals representing “credential maintenance activity” within the business setting. It is still another goal of this invention to provide such “credential maintenance activities.”

As credentials are maintained throughout time, certain historical events should be maintained. This can be accomplished by “credential and credential usage logging.” This is so, since a typical commercial environment is not future- and present-oriented only, and one has to maintain past relationships throughout the course of the transaction environment. An example is a setting of a contract fulfillment, where the various events are registered and marked for future reference. In an electronic world, the status of a credential at a given event and the fact that the credential was used to achieve a certain goal should be marked. The business environment may need the safe and secure logging of actions which are allowed by valid credentials to be maintained for a certain period of time which may be dictated by the duration of an activity or by regulation. This is particularly important in the financial sector where regulations imply certain historical management of credentials and being able to know along the time-line the status of credentials. This is not merely a logging of credentials, but an ability to manage the historical data and to analyze a state of trust in the past.

The temporal aspects are also important in supply-chain maintenance, where a supplier joins a company's supplier list and then is allowed access to some of the company's data by use of a credential. The joining event, as well as accesses to data, may need to be marked. When the supplier enters a contract with the company, the contract and the activities which follow may need to be stored and accessed by both the company and the supplier, and possibly by no one else (except for some legal entities authorized by the two parties themselves). It is another goal of this invention to provide for maintenance of the “historical credential data” and the “marking of events” in a proper, safe and legal way according to business rules suitable for commercial or other activities and status. This provides “historical management of trust.”

Certain activities may be short-lived such as a conference call over the Internet. The managed environment will need to support such activities, start, maintain and terminate them properly based on agreed upon rules. Other activities may involve changing, delegating and re-storing of credentials in the system. For example when a user leaves on a trip with his laptop, his ability to perform certain actions may move to the laptop he carries around, whereas other responsibilities may be delegated to a group of peers. It is another goal of the invention to provide for the temporal assignment of capabilities for limited terms and for delegating activities.

The utilization of business (or any other organizational) processes within the transactions environment, and knitting trust relationships and management rules inside existing business transactions and business history in order to provide for applications based on credentials and trust, are other goals of this invention.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates an exemplary computing environment;

FIG. 2 illustrates an enrollment process in which a prospective member establishes a credential for use in a community;

FIG. 3 illustrates an example of use of a credential by a member;

FIG. 4 illustrates a process in which a community-member's credential is suspended by the community;

FIG. 5 illustrates a process in which a community-member's credential is suspended by the member itself;

FIG. 6 illustrates a process of archiving a data object such as transaction records, executed contracts, etc., in a repository;

FIG. 7 illustrates a process of retrieving a previously-archived data object from a repository;

FIG. 8 illustrates a more expanded environment for a community;

FIG. 9 illustrates an example of managing a temporal activity; and

FIG. 10 illustrates process by which an authorized security officer would implement a rule change.

### DETAILED DESCRIPTION OF THE EXEMPLARY EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In a preferred system, there are various levels of trust management and relationships.

First are the basic trust-creating agents and data, such as credential representations and protocols requiring the checking of trust relationships (like signature and certificate validation methods, logical interpreters of trust relationships, access control capabilities in a system, etc.).

Second are the static and direct management of the trust relationships. These traditionally are trusted third parties such as certification authorities.

Third are ad hoc relationships management which are flexible and based on the organizational make-up of the bodies participating in the system that exploit the trust relationships (e.g., security officers, personnel managers, help desk employees in the information technology department, security servers, existing secure devices in the system, etc.). They are equipped with access to the security system which manages the trust. They can also replace the static relationship in direct management of trust components/credentials and do the work of the second type above, but be closely integrated with the business management. The above components can manage long-term trust relationships as well as temporary relationships. A long-term relationship can be trust management inside a company where the employees change, or managing of the customer group of a bank as the group changes and the bank offering changes as well. Temporary relationships may be a definition of a collaborating group for a well-defined period of time, like an electronic conference over a computer network, an ad hoc group for authorizing a report inside an organization, etc.

Fourth are the mechanisms which manage trust along the time line, namely, the maintenance of historical trust relationships. This component should be able to answer questions regarding the state of an activity in the past, e.g., if on a certain day the people present in the room were a specific group, whether one of them had an authorization to access certain data, and whether the data was accessed. These components can also be integrated with the business flow as the third type of components and are also part of the invention.

The management of credentials and trust relationships will be described in the context of a transaction system environment. The preferred embodiment deals with a credential represented as a public-key certificate, but it can also (or alternately) include credentials using data objects for other mechanisms such as passwords and biometric information.

The computing activity may involve collaboration of various sorts of entities: individuals, hardware devices, software agents, servers, proxy servers, representatives of organizations, inter-organizational consortium members, international organization representatives, and so on. The environment needs to be maintained in an ad hoc fashion as the nature of transactions supported by trust relationships dynamically changes. The maintenance itself should be trusted, flexible, dynamic and safe and should be well integrated into the environment relationships as they change. It cannot be static or depend solely on some devices certifying keys or entities once and for all. In fact, dynamics and change are crucial to any organization. Such changes are reflected in the organization's information technology being dynamic and flexible. When dealing with general trust and credentials within an organization, manageability of changes and flexible organization are required as well.

The system comprises various primary processes. For example, in a financial trading network, primary processes may include offering securities for sale and placing orders to purchase securities. With each primary process there is a “management process” in charge of assurance and safe operations. Other management processes are available in the system.

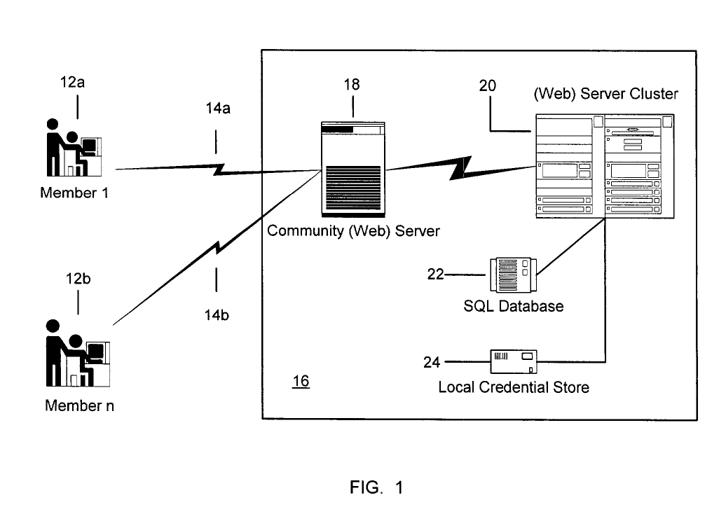

FIG. 1 illustrates an exemplary computing environment. A Community Representative 16, be it an exchange, consortium or other form of affiliation, maintains a system for managing credentials that are used in carrying out activities of the community. Community Members 12a, . . . , 12n communicate among one another and with the Community Representative 16 through communication channels 14a, . . . , 14n. The Community Representative 16 may be an individual, an independent organization, or other entity, and might be operated by or as part of one of the Community Members 12a, . . . , 12n.

In a preferred embodiment, Community Members 12a, . . . , 12n communicate with the Community Representative 16 through a communication server 18 that may be a Web server. The Community (Web) Server 18 in turn has access to additional resources, including a (Web) Server Cluster 20, a Structured Query Language (SQL) Database 22, and a Credential Store 24, all for carrying out credential management and other processes.

The Community (Web) Server 18 hosts both primary and management processes. Primary processes carry out activities of the community, including routines and known processes for conducting communications over communication channels, such as hosting a website, firewall protection, digital signing, routine message signature verification, etc. It also may include a collection of Java classes for community-related processes. Such code may be static Java methods that work like a method-call for the community's communication (web) code. It contacts the (Web) Server Cluster 20 “under-the-covers” using a secure XML interface. It can receive requests to initiate credential-management operations that rely on other resources, such as requests to add a credential to the credential store, enable a credential, disable a credential, check status of a credential, etc.

The (Web) Server Cluster 20 performs a variety of primary and management functions relating to community activity. It responds to secure XML requests from the Community (Web) Server 18, performs requested tasks, and returns a response to the Community (Web) Server 18.

The Local Credential Store 24 maintains a store of credentials, along with an “enabled” bit, the name of the community for which it is stored, and other information. It may be implemented as an SQL table. It may also include additional functionality associated with PKI certificate directories, such as an ability to receive certificate revocation lists, “pull” status information from other sources, etc.

The SQL Database 22, which may be implemented as a distinct architectural entity from the Local Credential Store 24, maintains historical and other information pertinent to the community's activities.

Participants, including community members and the Community Representative 16, may be any entity, such as a natural person, an organization, or a device. It will be assumed that each component in the system is implemented using a digital computer with an account inside an information processing system. Some components may be operated by a natural person. For example, a member may be a natural person operating a computer workstation that is part of a local area network and having access to the worldwide Web. Each member would have access to a communication subsystem for sending messages among the participants. The participants employ cryptographic operations, either in software or hardware, either on their computer or in a trusted device attached to their machines via a cable or a wireless device. Each participant may be part of a separate organization, each with its own local administration, security, firewalls, etc. The communication system is capable of inter-organization service.

Introduction of Credentials

When an entity seeks to become a member of the community, the entity undergoes an “Introduction-of-Credential” process. Whereas a typical, prior art system might rely on a single, common certification authority, trusted third party, or a collection thereof to issue a credential for a new member, the preferred embodiment accommodates a variety of processes for generating credentials. There may be multiple, potentially unrelated sources of credentials.

A user credential can be imported. A member might already have a credential obtained from a source outside the community, such as a PKI certificate issued by an independent certification authority. Alternatively, a prospective member might operate its own public key infrastructure and issue a credential to itself. In yet a third scenario, a prospective member could download software from the Community Representative 16 that generates a credential.

The introduction of the credential into the system involves a prospective member presenting its credential to the system by employing a communication protocol. An instance of a process, referred to here as “Management-of-Introduction-of-Credential,” runs within the Community Representative 16, communicates with a user, and is associated with a prospective member's credential-introduction event. A prospective member presents its credential to the Management-of-Introduction-of-Credential process, which checks the credential according to a set of rules enforced by the Community Representative 16. The Management-of-Introduction-of-Credential process may invoke a “Credential-Checking” sub-process that verifies a set of conditions required before a credential will be accepted by the community. The Credential-Checking sub-process potentially goes outside the system to check with the process that originated the credential. For example, if the credential was a PKI certificate issued by an independent certification authority, the Credential-Checking sub-process might query a directory associated with the issuing certification authority and “pull” the validity status of the certificate. Alternately, if a prospective member uses software supplied by the Community Representative 16, the Credential-Checking sub-process might wait for a complementary action to come from the Management-of-Introduction-of-Credential process to “push” the required validation. If no validation information is obtained in the normal course, the Credential-Checking sub-process might activate an “introduction-exception-handling” process whose task is to notify a human operator to intercede and perform out-of-band validation.

When a credential is validated successfully, the Management-of-Introduction-of-Credential process is notified, which, in turn, activates a “Credential-Publication” process. The Credential-Publication process checks a user's affiliation and status inside the system. This can be done by checking with a “User-Management” process, such as a report of status from a personnel department inside an organization, or by assigning a status based on a contractual agreement inside an inter-organizational body. After checking, the Credential-Publication process publicizes the credential and its status. The publication can be done by entering the credential into one or more databases which are safely managed. Alternatively, the publication can be given to the now-enrolled member itself in the form of an internal credential validating a user's community credential.

Rather than importing a credential, a user may generate a credential, or it may activate a proxy generation process to do so. The generated credential is then introduced into the system. For example, the credential may be generated by generating an asymmetric key pair as part of a public key cryptosystem, by recording a biometric sample, or by obtaining some other distinctive characteristic to be associated with the entity.

Rather then going outside the system to validate the credential, an “Internal-Credential-Validation” process is activated. In this case, a prospective member has to prove the ownership of the generated credential and the introduction management approves the credential based on the community's rules. The proving process may be based on existing channels of authentication. One such channel may be the user out-of-band identifying itself to a help desk operator which approves the association of a credential and a user. Another scheme may rely on a user already holding a credential (say a password) and the fact that a user can, based on its password, log into a database server and post its newly generated credential. Once the credential is validated, the publication process proceeds as above.

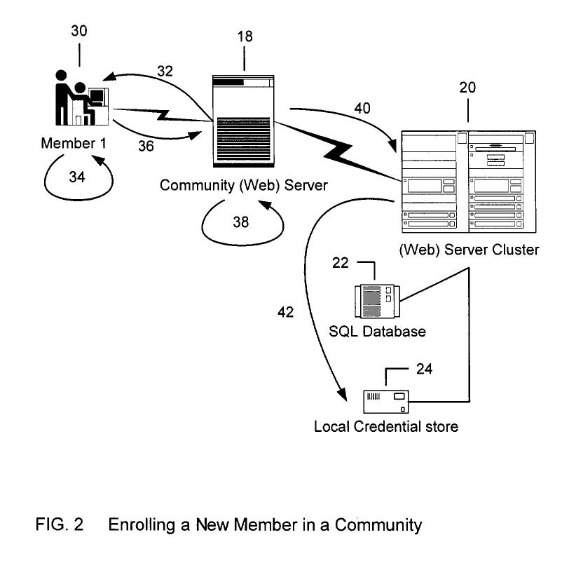

FIG. 2 illustrates an enrollment process in which a prospective member utilizes software provided by the Community Representative 16. Steps in the process are indicated by arrows. The Community (Web) Server 18 hosts a website. A prospective member 30 may be an employee of an organization or other user operating a workstation connected through a local area network to the Worldwide Web. A prospective member accesses an enrollment page of the community's web site. In a download step 32, the (Web) Server Cluster 20, working in conjunction with the Community (Web) Server 18, downloads an application in the form of a browser “plug-in” (e.g., Netscape™ plug-in, ActiveX™ control, custom application in C++ or VB languages, etc.). In a credential application step 34, the plug-in either (a) obtains an existing credential from the prospective member, or (b) generates a data object for use as a credential.

If a prospective member has a preexisting credential that it wants to use in conducting community activities, the plug-in can obtain the credential from the community member. An example of a preexisting credential could be a PKI certificate and its associated private key. The credential and associated private key might be stored directly on the community-member's workstation, on a smart card, or elsewhere.

Because different sources of credentials might use differing software and techniques for managing credentials, the plug-in may include (or have access to) a variety of subroutines specific to particular credential sources. For example, one credential issuer might use software that stores a secret key on a smart card with a first application program interface (API), while a second issuer might use software that stores a secret key in a hidden location on a disc drive using a different API. In addition, the computing system used by a prospective community member might have multiple credentials. The plug-in preferably has access to a variety of subroutines for receiving credentials from a variety of sources, and for obtaining the correct credential. To the extent that a prospective member would continue to maintain the credential for use in other contexts, the plug-in should have the capability to continue to access the credential.

If a prospective member does not have a preexisting credential that it wants to use in conducting community activities, the plug-in can generate one. For example, the plug-in might create a PKI certificate that is compliant with the X.509 standard by: (a) generating a private and public signature key pair of a public key cryptosystem, (b) creating a credential in the form of a PKI certificate containing the public verification key, (c) signing the certificate using the generated secret signature key, and (d) prompting the prospective member for a Personal Identification Number (PIN). After receiving a PIN, the plug-in stores the keys and the certificate on a prospective user's workstation or smart card. The plug-in might alternately generate another data object for use as a credential.

The plug-in may perform a number of additional, desirable functions, such as: (a) accessing local directories and files that the plug-in might use on a prospective member's computer, (b) checking operating system software versions, (c) checking for the presence of particular resources, such as a smart-card reader and smart card, (d) allowing access to, and election of a number of credentials which might be used by other applications, (e) reading other credentials (e.g., by decrypting or otherwise opening containers or tokens containing unique information), etc. The plug-in might additionally provide encryption/decryption capability, and other key management functions.

In a presentation step 36, the plug-in uploads the credential (whether preexisting or self-generated) to the Community (Web) Server 18, along with other data, such as a prospective member's name, address, phone number, email address, etc.

In a verification step 38, the Management-of-Introduction-of-Credential process running on the Community (Web) Server 18 (or alternatively on the (Web) Server Cluster 20) applies rules of the community to determine whether to accept a credential. If accepted, the Management-of-Introduction-of-Credential process communicates the credential to the (Web) Server Cluster 20 in a communication step 40. The (Web) Server Cluster 20, in turn, stores the credential in the Credential Store 24. The (Web) Server Cluster 20 may also store other information in the SQL Database 22, such as event information about the time of credential presentation, the processes used to validate the credential, and information about a prospective member. Upon storage of a credential in the Credential Store 24, a prospective member becomes an enrolled member.

Any of the above processes can be handled in batches, where the users are introduced as a group by a “Security-Officer” process that represents the users (members of the same organization) to the system. The above processes take place handling the batch rather then handling individual users. Users can be any type of entity inside the system.

The above processes can be modified to include mechanisms associated with a “registration authority,” where entities register their keys and authenticate themselves.

The above processes can be augmented so that the “Internal-Credential-Validation” process invokes an internal certification authority that issues certificates in replacement of the presented credentials. The process can also serve for cross-certification, bringing credentials from one certification authority to be certified by another one, or to have a collaboration of a number of authorities. This enables organizations to operate a joint activity in a trustworthy fashion, such that their credential holders may be mutually recognized.

It is also possible that credentials that were introduced and maintained ad hoc in a local community will be transferred to a CA at some later time to go through a traditional CA-issuance process. This could correspond to changing the ad hoc rules to require new credentials to actually be certified by that CA, though it would not necessarily imply that the old credentials could not be certified.

The credentials may also indicate the status of a key and its origin. For example, a key which is imported inside a hardware device may have higher security than a software-generated key which is locally encrypted with a password. Various classifications, such as level of security and sources and origin of keys, may be part of the credential.

Credentials can be used together with an “authorization” or an “access control” engine that decodes the actions the owner of the credential can perform when accessing various resources and utilities in the system. Management of the authorization and access control tables is known in the art and can be a component of ad hoc management.

Credential Use

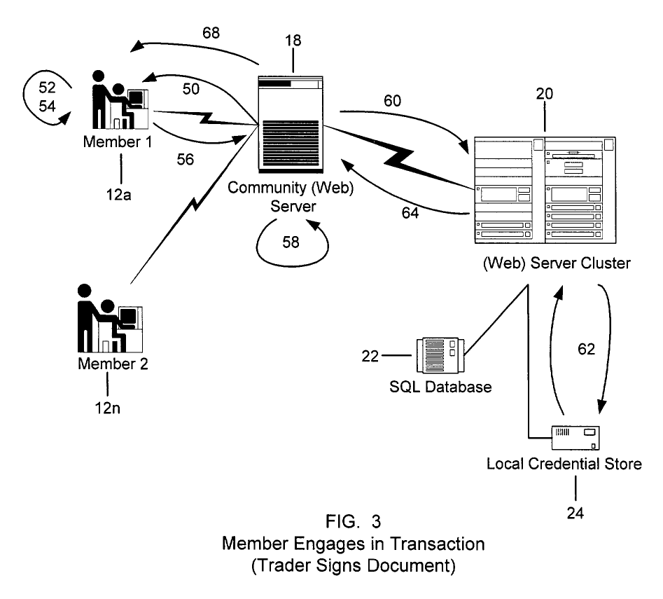

FIG. 3 illustrates an example of use of a credential by a member. In the example, a community member signs a document. In presentation step 50, the Community (Web) Server 18 displays something to be signed, which might be a web form, a text document, or other data object, along with administrative instructions (such as a “sign this” button). In an acceptance step 52, the community member 12a clicks on the “sign this” button. In an authorization step, a plug-in (previously downloaded to the community member's browser) prompts the community member operator with a notification asking for the signing PIN associated with the community member during credential registration. In a signature step, the plug-in: (a) computes a signature; (b) adds a timestamp, (c) appends signature bits to the object being signed, and (d) uploads the signed object to the Community (Web) Server 18.

In a validation process 58, the Community (Web) Server 18 checks signature bits using the credential and the data. In a Credential Validation step 60, the Community (Web) Server 18 invokes the (Web) Server Cluster 20 to check the validity of the credential. In a credential retrieval step 62, the (Web) Server Cluster 20 retrieves the credential for the community member from the Local Credential Store 24. In a reporting step 64, the (Web) Server Cluster 20 verifies the signature and reports the result to the Community (Web) Server 18. In an audit recording step 66, the (Web) Server Cluster 20 also records information about the transaction in the SQL Database 22. In a confirmation step 68, the Community (Web) Sever 18 reports to the community member 12a whether the signature was accepted and any error messages.

Managing Credential Directories

The community includes management processes that collect and record information about credentials. This includes a messaging system where “credential reports” are collected. Reports can be sent by entities holding credentials, by management processes, such as a security officer within an organization, by processes which check credentials in operation, and by other members of the system. Each report has to be authenticated and validated to assure that the source is correct. The sources themselves may be managed by a sub-system of credentials, which are managed separately as part of the definition of control and administration of management. A report gets into the system, and the community manages the credential via a safe directory, which is accessible for manipulation only by the management process. When a manipulation-of-credential report is received by the Community Representative 16, the message is validated. If found to be valid, the manipulation request is performed. The Community Representative 10 obtains authorization to request a change to the database system, which guards the credential repository, and the manipulation is then performed.

Once a report about a credential is achieved, an action is taken by a Credential-Management process operating on the (Web) Server Cluster 20. There are credential manipulation operations and credential query operations. Credential queries are associated with utilization of credentials, where elements of the system query to assure trustworthy utilization of credentials.

One manipulation is “publish credential” discussed above. Another set of manipulations may be the changing of the status of a credential. One such change is “Revoke-Credential” which causes the publication of the revoked credential in some file and/or marking indicating that a credential in a credential repository is revoked. Another operation is “Suspend-Credential” which can be done by the user itself (self suspension) or by any of the reporting agents (subject to community rules). Suspension can be effective until a “Renew-Credential” appears in the system. “Renew” can also be done based on a time when the original suspension was with a time or date limit.

The status of a credential may have more semantics, and the credential repository may express capabilities which can be manipulated in a smaller granularity while keeping the credential valid. They can be changed and/or modified. This is typical when the business process connected with the credential is based on some quantitative measure. For example, in a financial environment, the credential may be associated with some amount of money, and the amount can change and be manipulated by the system. Other authorization fields may be manipulated similarly. The manipulation may have temporal aspects associated with them, such as the example of a time limit for suspension. The semantics may further impose context limitations, such as allowing a credential to be valid only during a certain shift (time period during every day), or only at a time when another credential is valid.

Manipulation of groups of credentials may also take place. A credential may be authorized to join another set of credentials so that together they are authorized to perform certain transactions. The limits and amount of collaboration may be dynamically managed. This can be used in conjunction with known collaboration systems that otherwise lack ad hoc management capability, such as Lotus Notes.

Status of a credential may also be limited by scope and geography and by other system parameters. The scoping can be managed as part of the status of the credential. For example, an authorization credential might only be valid for accessing information that is published in the USA and Europe, but not elsewhere.

A credential querying process is performed by a system's user by sending a request to a manager process that probes the credential database and answers the request. For example, a request may ask for a status, whether a credential has certain properties. The requester and the manager answering the request may authenticate their messages by signing it to assure further integrity.

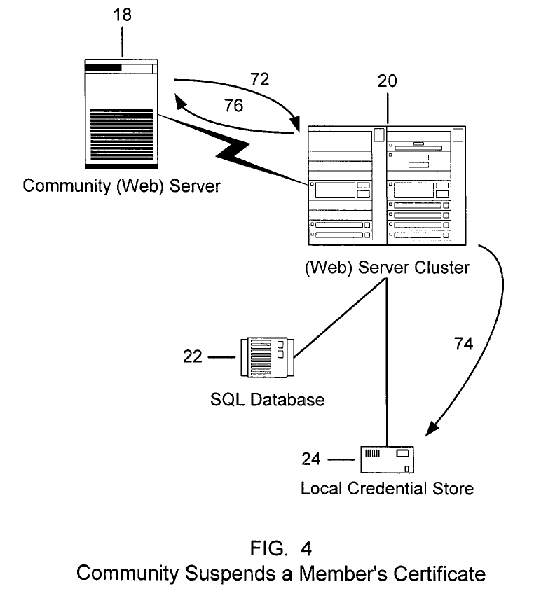

FIG. 4 illustrates a process in which a community-member's credential is suspended by the community (typically by the Community Representative 16). In a manual method, an authorized manager in the Community Representative 16 obtains information about a credential to be suspended and makes a decision to suspend according to the community rules. In an automatic method, external events might trigger the credential revocation. Regardless, an event 70 triggers the Community (Web) Server 18 to initiate the revocation process. In a communication step 72, the Community (Web) Server 18 calls a “Suspend Credential” process in the (Web) Server Cluster 20. In an update step 74, the (Web) Server Cluster 20 sets a “suspend” bit in a data field for the credential in the Local Credential Store 24. In a reporting step 76, the (Web) Server Cluster 20 reports to the Community (Web) Server 18 that the credential has been suspended (and/or provides other status information). The Community (Web) Server may optionally inform the respective community member that its credential has been suspended.

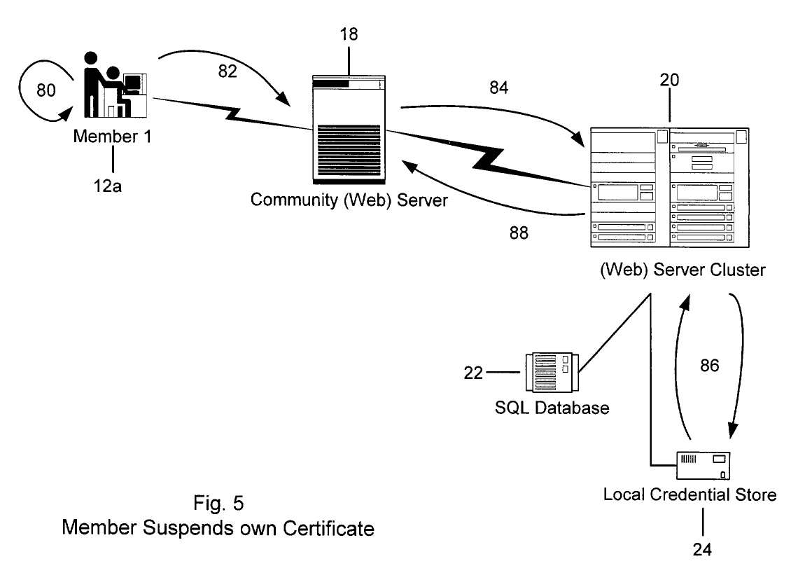

FIG. 5 illustrates a process in which a community-member's credential is suspended by the member itself. In a decision step 80, the community member 12a makes a decision to suspend its own credential and activates the previously-downloaded plug-in. In a notification step 82, the plug-in communicates a suspension-request message to the Community (Web) Server 18. In a communication step 84, the Community (Web) Server 18 calls the “Suspend Credential” process in the (Web) Server Cluster 20. In an update step 86, the (Web) Server Cluster 20 sets a “suspend” bit in a data field for the credential in the Local Credential Store 24. In a communication step 88, the (Web) Server Cluster 20 reports to the Community (Web) Server 18 that the credential has been suspended (and/or provides other status information).

In a reporting step 90, the Community (Web) Server 18 informs the community member 12a that its credential has been suspended (and/or provides additional status or error messages as appropriate).

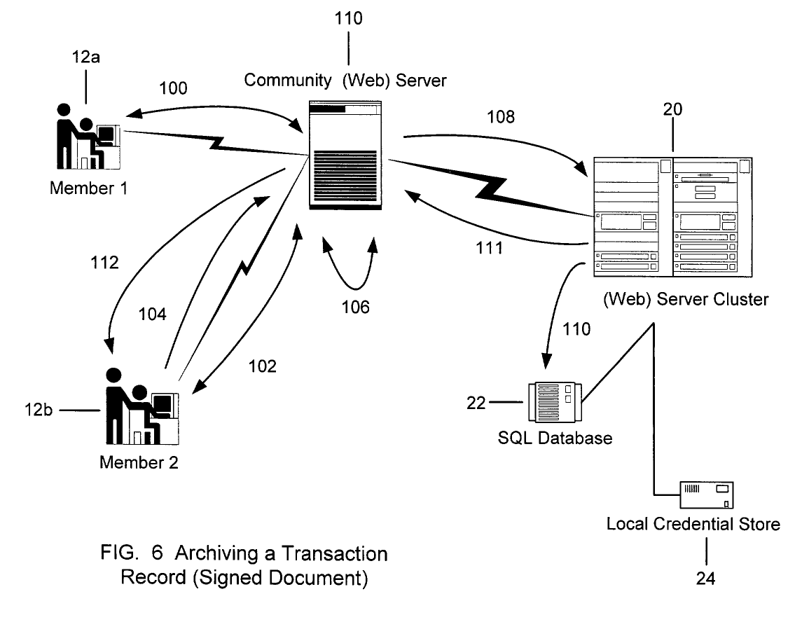

FIG. 6 illustrates a process of archiving a data object (such as a transaction record, executed contract, etc.) in a community repository. The example will be a transaction document that was initially hosted by the community and signed by two Community Members 12a, 12b. In a first signing step 100, the first Community Member 12a signs the document using the procedures described above under “Credential Use.” In a second signing step 102, the second Community Member 12b signs the document using the procedures described above. In a request-for-archive step 104, one of the community members (in this case the second Community Member 12b) communicates to the Community (Web) Server 18 that the signed document should be archived. In an administrative step 106, the Community (Web) Server 18 verifies various administrative information and appends a timestamp to the document. In an invocation step 108, the Community (Web) Server 18 sends the document (along with administrative information) to the (Web) Server Cluster 20. In a storage step 110, the (Web) Server Cluster 20 stores the document and administrative information in the SQL Database 22. In a first reporting step 111, the (Web) Server Cluster reports the result of the storage request.

In a second reporting step 112, The Community (Web) Server 18 reports the result of the archive request to the requesting Community Member 12b. The Community (Web) Server 18 may also report the result of the archive request to the other participating Community Member 12a.

The (Web) Server Cluster 20 may also record an “official” time of recordation for evidentiary purposes. The clock of the (Web) Server Cluster 18 may be maintained through formal procedures, such as documented synchronization with the Internet time services of the NIST or the USNO. Operators of the (Web) Server Cluster 20 may also keep exact logs of when synchronization was done and verified. Additionally, the (Web) Server Cluster 20 may be programmed to provide the time, sealed with a digital signature, to the community (Web) server(s), and client programs could obtain these time values from the exchange to include in the signature data. Making such a timestamp service available to the public through the Community (Web) Server 18, rather than directly from the (Web) Server Cluster 20, permits a comparison of the service requests against the specific exchanges. It also provides additional protection from hacker attacks against the (Web) Server Cluster 20.

The (Web) Server Cluster 20 can also provide a witnessing service for document signatures by keeping an evidentiary record of archived, signed documents. The witnessing service can be anonymous in the sense that the Community could publish a hash of a witnessed document in a trusted or public repository, and the Community might sign it as well and make it accessible at a web server. For such services, the system should be highly reliable and non-repudiable, e.g., by having devices sign log entries using device keys, adding cryptographic check sums to logging records, journaling to geographic redundant sites, etc.

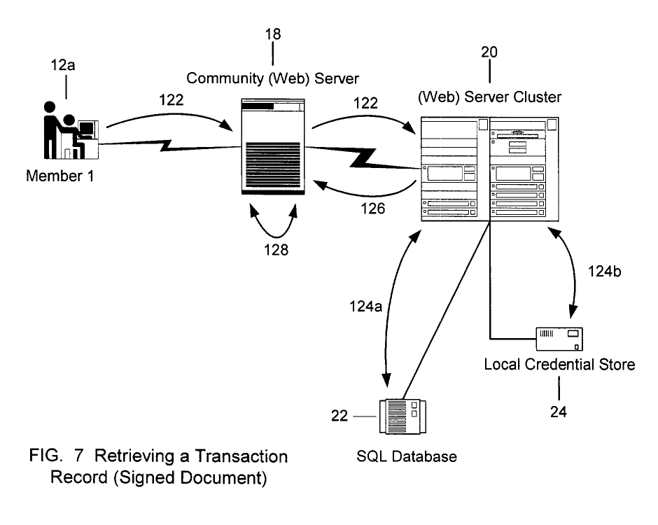

FIG. 7 illustrates a process of retrieving previously-archived data objects (such as transaction records, executed contracts, expired credentials, etc.) in a community repository. A Community Member 12a makes a decision to retrieve the data object for whatever reason. In a request step 120, the community member 12a accesses a community web page and communicates to the Community (Web) Server 18 a request to retrieve the data object. After making certain administrative checks, the Community (Web) Server 18 forwards the request to the (Web) Server Cluster 20 in an invocation step 122. In query steps 124a, 124b the (Web) Server Cluster 20 requests and receives the data object from the SQL Database 22 and the credential from the Local Credential Store 24 that was used with the data object. In a first reporting step 126, the (Web) Server Cluster 20 reports the result of the invocation to the Community (Web) Server 18 (e.g., the data object or an error message). In a display step 128, the Community (Web) Server 18 displays the document (or other result message) on the Web page. Alternately, the Community (Web) Server 18 might securely report the result to the Community Member 12a, or report through an alternate choice (such as email).

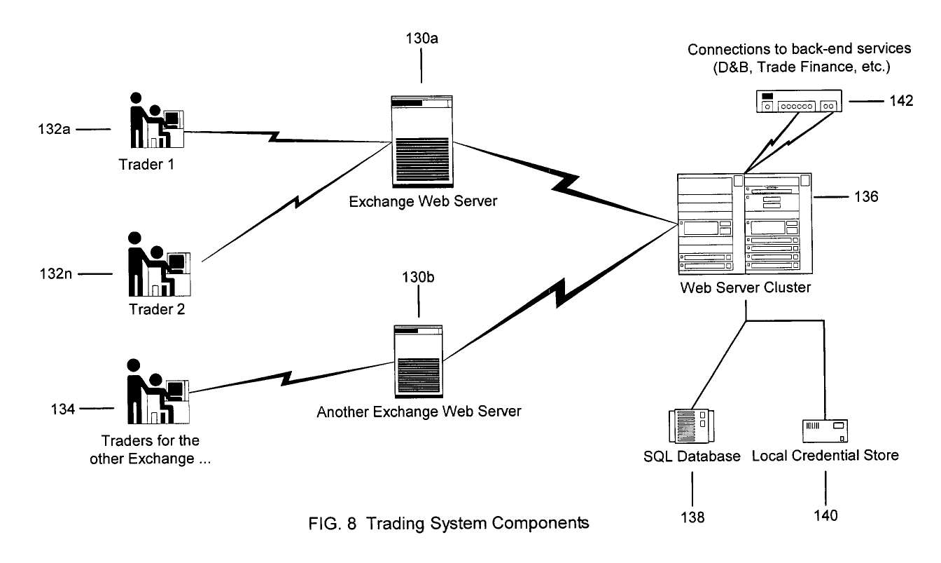

FIG. 8 illustrates a more expanded architecture for a community. This particular architecture is contemplated for one or more financial services exchanges. In this case there are two potentially separate exchanges, each with its own rule set(s). A first exchange comprises a first Exchange Web Server 130a. The first Exchange Web Server 130a functions substantially the same as a Community Web Server 18 described above, and it serves a first community of traders 132a, . . . , 132n. The second Exchange Web Server 130b functions substantially the same as Community Web Server 18 described above except for a distinct (although possibly overlapping) set of traders 134. A common set of “back room” resources support both Exchange Web Servers 130a, 130b. The “back room” resources include a Web Server Cluster 136, a SQL Database 138, and a Local Credential Store 140. It will be appreciated that the SQL Database 138 and Local Credential Store 140 may be shared or replicated for each Exchange. The system also provides connections 142 to back-end services of interest to community members, such as Dunn & Bradstreet services, etc.

Preferably, information relating to such services passes through the Web Server Cluster 136. Information communicated to or from the back-end services may be signed either by their source or by the Exchange Web Server 130a to assure authenticity of information. Events may be archived according to community rules automatically and invisibly to the members. Directories may be split into sub-directories, e.g., a director for identity credentials, a directory for authorization credentials, a directory for non-PKI credentials, a directory for archived events representing actions authorized by credentials, etc.

A similar configuration works where the traders 132a-132n of FIG. 8 are actually members of the press and the back end services are commercial companies announcing important business results. A credential of the issuing company or of the Web Server Cluster 136 can be used to sign an announcement, thus assuring that the information transferred from the press release centers of the companies at the back-end are authentic and valid.

The flow of information can also go from the front end members 132a, . . . , 132n to the back end. For example, the traders 132a-132n might instead be companies, and the back-end service might be a credit-analysis service, such as Standard & Poor's (™). Companies can provide periodic financial statements to the credit-analysis service.

Configurations as in FIG. 8 may be part of an environment where sensitive information flows between the front-end 132a-132n and back-end 142 with services related to information-integrity, such as authentication, logging, time stamping, and revalidation. For security, such information may be encrypted. In fact many of the examples above can include encrypted information directed to owners of credentials, where the credential enables them to decrypt the information.

Logging Historical Events and Managing Historical Trust

A query process can also be performed on historical data in a community's database(s). A query may ask about the status of a credential at a given date and time. The historical database accumulates information as it keeps a log of the history of the status of each credential. To this end, each credential is associated in a history database with the events of manipulation and their dates.

Also, every usage of a credential, or selected sub-cases of usages, can be logged into historical databases. This enables queries referring to actual applications of a credential, such as for each transaction in a transaction-processing system. A request for identification, a signing of a document, or an access to a system resource can be logged and maintained. The status of every historical transaction can be retrieved by a query. This can support witnessing to various transactions over time. An example would be a loan process, where the money paid back in each installment is tracked, and the outstanding debt at each point in time can be calculated based on the record.

The entire logging process is signed and is accessed only by managers of the community with certain authorizations. (For example, each record in a database might be signed using a device key associated with the Local Credential Store 140 of SQL Database 138. It can be stored in various devices to increase the reliability and sustainability of the historical recording of the trust relationships and usages of credentials based on the existing trust relationships.

The fact that the system holds the historical data and can automatically calculate answers to a history-referencing query enables access to the trust history. This access enables the management of a trustworthy process over time (such as the above loan example) and enables the management layer to recognize the state of trust relationships at some point of time. Based on such states, the management may modify and refine, or abort, certain relationships in order to make the operation smoother and more secure. The notion of “trust history” in a system that manages trust relationships, credentials and events authorized by credentials, adds operational and management power in managing long term relationships and events. Such power results at least in part from the flexibility associated with an ad hoc credential system built to maintain changing rules, while at the same time logging the rules-changing events as part of the historical data. An example would be the loan case described above. If the rules of payments change (e.g., in a variable interest loan), such change can be recorded and the loan management over time can be continued smoothly.

Managing Proxy Processes (Mobility, Agents, Etc.)

Entities in the transaction system are allowed to manipulate their own credentials. They can delegate power to themselves in an authorized fashion by issuing a new credential and signing it with an old credential. They can deposit a credential signed by the old credential in a directory and designate a life time for the new credential. Credentials can authorize proxies to act temporarily on their behalf. The above procedure enables entities to be mobile and to delegate to a mobile device a new, credential-related key rather then exposing the private key associated with a credential. An entity may delegate part of its credentials only, it may limit in time and geography the applicability of the proxy or delegated processes.

The system supports the above actions, by having a manager whose task is to notify system components of the manipulation of credentials done by a user (entity), and the new credential he issues. For the process to be trustworthy, the user has to apply his credential's private key to make sure the credential delegation and manipulation is an authorized action. The manager checks the validity of the proxy/delegation and indicates it in the system by manipulating the proper database.

Consider the case where the credential is a certificate of a key whose private key performs a digital signature computation when the credential is in use. This credential can be delegated to an environment where it is on a relatively insecure device that cannot be trusted to maintain secrecy of the signing key. Examples include laptops, personal digital assistants (PDAs), and other mobile devices, Internet-connected hosts, etc. Alternately, a credential may be delegated to a server from a secure environment of a user. The delegation can be limited to a time period. In another case, a user who is actually a server wants to delegate to a number of other servers (locations) temporarily (e.g. a server is being taken off-line, and the rule is to have a proxy acting on its behalf).

In one scenario, the user operates from a number of relatively small and fixed locations. The user can represent himself as a multitude of separate credentials, one for each location. This is a static arrangement where no actual delegation takes place.

In another scenario, the user's key-containing device can be physically deposited at some proxy server that receives a password to activate the device. When the user wants a signature, he activates the device remotely with a password protocol or a one-time challenge protocol. It is required however that the task to be performed is designated by the user, so for example the user can perform some operation like take a message digest of the action or information needed to be signed and encrypt it under the shared password/one-time password. This assures that the action the server follows is what the user actually intends to do. These rules can be implemented and assure that users are mobile.

Another method would be to delegate use of the signing key from the permanent credential holding-place by using it to actually sign new credentials (new certificates that is). The permanent signing key acts on behalf of the user against the server locations or against the laptop device at a time period. The delegated credential can be created once per time unit (a day or a month) or it can be created for every different location, or every time the user requests a roaming event with a certain device to be the delegated equipment. To minimize the damage caused by exposure of secret keys, the signing key stored on the insecure device is refreshed at discrete time periods via interaction with the main credential holder. If delegation is to different servers, instead of over time periods, delegation can be renewed afresh at each location

The above can be implemented by the having the permanent holding place have a signing key S, and having it generate a new signing key for each time period using some randomness obtained from some pseudorandom function mechanism F and a seed (which is known in the art which on each input generates a random result). Every time period x (or every location x), the public key V(x) and its private signing key portion S(x) are generated using the randomness from the pseudorandom function evaluation when computed by F(seed,x). The new public key is put in a credential (e.g., a certificate structure) C(x) which includes V(x) and is signed by the permanent signing key S. Call this signature S(C(x)). The generation via the pseudorandom function assures that, for each time period/ location x, the compromise of the local key S(x) does not give any information about another key in period/location y (y different from x); so that S(x) reveals nothing on S(y).

The rules of updating credentials (and making sure of their independence and security) are controlled by the rules of the environment. A verification of a signature first verifies the signature S(C(X)) to assure that the certificate C(x) is valid and then applies V(x) as a verification signature to signatures from time period/location x.

Delegation and proxy rules between elements and in the time domain are part of the ad hoc agreements on how credentials can be managed in the environment. The delegated credential action has to be known system-wide, and verifying partners and parties have to be part of the agreement. Without such global coordination of rules, verification will not be possible. The power of ad hoc management is that rules like verification as above can be turned on ad off as delegation is allowed or forbidden within the system or a subsystem.

The above is an example of the rules of management of storage of credentials as the system evolves. Other cases are possible. In one scenario, a user can delegate to a number of locations, and the rule may require that a quorum or a majority of locations will apply their credentials. Other aggregation rules may apply. Rules determining the scope and composition of a valid credential application are part of the management of credentials. Such rules can help manage who access what. Another such scenario is when the user temporarily stores its credential activation capabilities at various locations and will be able to retrieve them based on other credentials it will present.

Managing Temporal Activities

Similar to proxy and delegation, a management component can assign a group for collaboration, conferencing and any other joint activity. For this a temporary credential is generated for each user, and it is given to the respective user. The users are then authorized to take part in this temporary activity. The activities and the trust-related events in them are logged.

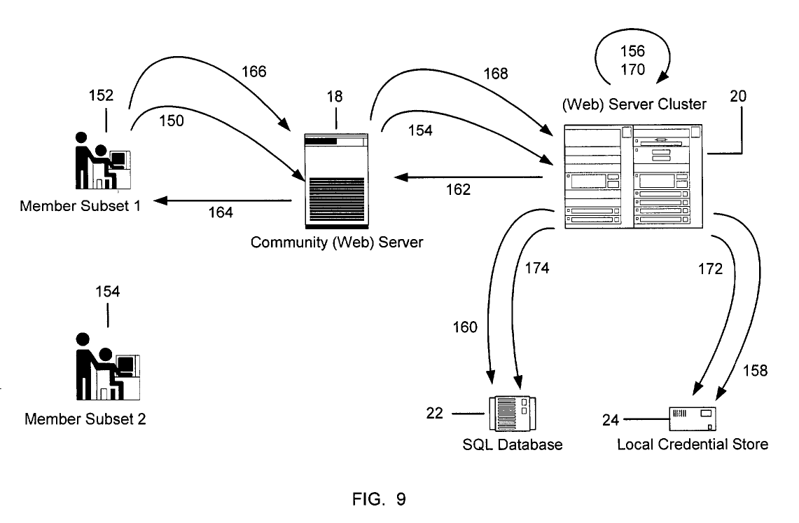

FIG. 9 illustrates an example of managing a temporal activity, i.e., an anonymous vote by shareholders at a company's annual meeting. In a registration step 150, shareholders 152 would register permanent credentials to be enrolled in a community. Other members 154 of the community might include employees who do not own shares. In a voter-registration step 154, each shareholder 152 uses its permanent credential to obtain from a vote-manager (a process running on (Web) Server Cluster 20) a temporary credential that does not reveal the member's identity. A member might get a temporary credential for each share. In a credential-generation step 156, the (Web) Server Cluster 20 generates credentials. In a credential-storage step 158, the (Web) Server Cluster 20 records the new credentials. In a logging step, the (Web) Server Cluster 20 logs administrative and event data in the SQL Database 22. In a first credential-reporting step 162, (Web) Server Cluster 20 reports the credentials to the Community (Web) Server. In a second reporting step 164, the (Web) Server Cluster 20 reports credentials to voting shareholders 152.

At election time, each temporary credential is allowed to cast a vote in every resolution that is before the shareholders. In a voting step 166, each shareholder uses a temporary credential to sign a vote and post it with the Community (Web) Server 18. In a vote-recording step 168, Community (Web) Server 18 notifies the (Web) Server Cluster 20 of the votes and associated credentials authorizing the respective votes. In a validation step 170, (Web) Server Cluster 20 validates the temporary credentials and votes (including a step of retrieving the temporary credential status from Local Credential Store 24). In an update step 172, (Web) Server Cluster 20 updates the status of properly-used credentials to show that a credential was used and may not be used again. In another logging step 174, the (Web) Server Cluster 20 records information about the voting event(s). Once a temporary credential is used, it is not usable for any other purpose and it automatically expires. (For example, all temporary credentials have an expiration time that is the time limit allowed to complete the vote.) From the information on the Community (Web) Server 18, each shareholder can inspect all votes and compute the tally to verify the election result. Because the temporary credentials do not reveal information about the identity of the shareholders, each shareholder's vote is confidential. The voting result may be certified by an entity that is designated by a credential to announce the results.

Rules

The community operates according to rules which may be defined for individual actions. Some examples will be given here.

(1) Accepting a new member into the community. A member may be accepted into a private community when sponsored by two members in good standing. The sponsorship may be anonymous, in that the two members do not give personal identifying information about the proposed member. The attested-to credential, while containing a unique public key, contains no personal name or email. The members need not vouch for the identity of the prospective member. The sponsoring members merely attest that “I sponsor the entity whose credential is XXX.”

Alternatively, an entity may be accepted on an ad hoc basis if it presents a credential issued by the CA used by a similar community. This may be desirable if the two communities have established a policy of reciprocity, and the second community uses CA-based credentials. There need not be a real-time check for the validity of the credential (via CRL or OCSP or similar mechanism), unless the two communities, by their mutual assent, have established this as part of their rules for reciprocity.

Alternatively, an entity may be accepted on a permanent basis if it presents an anonymous credential from a third community, and by the mutual-assent rules of the two communities, the credential is reported as “acceptable” when the first community inquires with the second community. Under the mutual-assent rules, the inquiry may be made on every use of the credential for a signature. An example would be an international community where countries issue passports to their respective citizens and, based on such credentials, citizens of one country can enjoy certain privileges in another country.

Alternatively, an entity may be accepted with any credential whatsoever, and certain privileges may be permitted (e.g., ordering merchandise from a catalog). An after-the-fact check on the credential may be made using more stringent rules (e.g., the entity meets one of the other criteria, or is a credential issued by a major credit-card company and the credit-card company says there is a particular level of credit available) before certain additional privileges are permitted (e.g., ordered merchandise is actually shipped). Such arrangement may be used to encourage awareness as much as possible of available electronic goods and stores, yet restrict financial transactions to a higher level of credential-checking.

Alternatively, an entity's credential and signature may be accepted with no checks. For example, an entity might wish to engage in a transaction, such as offering certain items for sale. The information about the item may be listed on an exchange. By the mutual-assent rules of the community, other members will be informed that the items are for sale. However, no offer for purchase can be extended by a purchasing member until certain other criteria for acceptability are met, e.g., the purchasing member provides two written letters of reference from a major financial institution.

(2) Suspending Membership. Each entity may be entitled to “suspend” its own membership at any time. The community may make a Web page available on the public Internet (or community intranet) so that any member who presents a previously-accepted credential and matching signature can “suspend” its own membership immediately. The validity of the credential in other settings would be unaffected. For example, a supplier might join a community that supplies a manufacturer by presenting a certificate from a CA. The supplier might suspend membership in the community of suppliers without revoking the certificate. This would also be useful, for example, in allowing parents to control use of a shared credential by their children, or to prevent unauthorized use of the credential if the member suspects it may have been compromised or duplicated.

Alternatively, a community may establish by mutual assent that members must pay a monthly membership fee. Members whose fee is more than 30 days in arrears may be automatically suspended. The credential would no longer be valid within the community, but it may be perfectly acceptable in other communities.

Alternatively, a community might waive a suspension requirement by mutual assent. For example, any group of 10 members in good standing would vouch for a member in arrears, and any suspension that otherwise would be required would not apply.

Alternatively, a community can established that members whose credentials are listed in a public directory of members of a rival community will be suspended and excluded automatically and unconditionally.

The above rules are not fixed and can be managed dynamically as situations between communities and entities change. For example, reciprocity rules between countries may change as diplomatic relationships evolve. Also, children may grow and their status and rights change when they reach certain ages.

Managing the Management Processes

The community system is managed (out of band) by business rules and technical procedures that are made available to the organizations running the transaction system. The system is also managed by management and configuration software inside the system. In the system definition, service is declared to participants under some strict management procedure, but any inter-organizational “coordinated collaboration” can be managed. The following is done:

(1) The “management rules” for the collaboration are defined.

(2) The management rules are translated into technical tools such as directory management which defines who is who in the collaboration and how the management carries the required trust. Communication rules are determined as well.

(3) The management of credentials for initial trust is registered into the system. Organizations may register (part of) their local PKI into the collaboration; they then suspend, revoke, update, etc. within the “collaboration rules.” These rules are either independent or are tightly implied by the management of the sources of credentials, e.g. a revoked credential in the intra-organization system will imply revocation at the collaboration level.

(4) Exception handling and management manipulation rules are determined.

The above involves defining processes in the system based perhaps on business rules and functions of entities which make up the management layer. The above are performed by defining roles in the database management system and determining authorization and access to databases and security directories including credential directories. A small core public key infrastructure can be managed in order to control the management process itself.

At this point each trustworthy process has a manager. The system operates on two levels: (1) a management level is managed based on ad hoc agreements based on the system's and the organization's ad hoc business needs and similar reasons, and (2) an operational level controls the entire system.

The management level itself can also be split into sub-layers, such as intra-organizational and inter-organizational levels. These two systems are related. What results is a credential system based on closed-system agreement. Its implementation and trust agents are determined. For example: a security officer and the personnel manager within an organization are the agency to register users in the local directory. On the other hand, the security officer and the CTO are the agency to register users in the inter-organization collaboration. The CEO registers and manages these two agencies. In both inter- and intra-organization, the “management layer” is a flexible thing that can be determined within an effort.

The advantage of the above transaction system, which manages the credential in a business-oriented transaction system according to the need of the applications, is that a traditional certification authority is a very rigid starting point that may not fit all organizations. Making the “trust agents” a flexible possibility which may vary inside an organization (yet is assured to be trustworthy and secure) is a better way to organize the credential system within the organization.

The management of the managing process can be performed by melding the credential-management system and rules-engine as discussed above with a semantically-rich, database management schema, especially distributed database system management tools. They enable definition of roles and authorizations within the system and can manage the access to the engines which codify the rules within the trust-management system. The combination of management tools, such as a DBMS (data base management system) as the control over the system for trust management allows the flexibility to represent and manipulate the ad hoc rules of the trust-management system. DBMS itself can be secured by its own credential system.

By way of example, a process for enrollment was described with reference to FIG. 2. In a case where a prospective member would be permitted to use a credential from third-party CA, the system would have at least two database entries to support such credentials. Either the Community (Web) Server 18 or the (Web) Server Cluster 20 would maintain a table of acceptable CA's. In addition, the Local Credential Store 24 would include a credential from each CA (e.g., a public key certificate from each CA used to verify the respective CA's signatures).

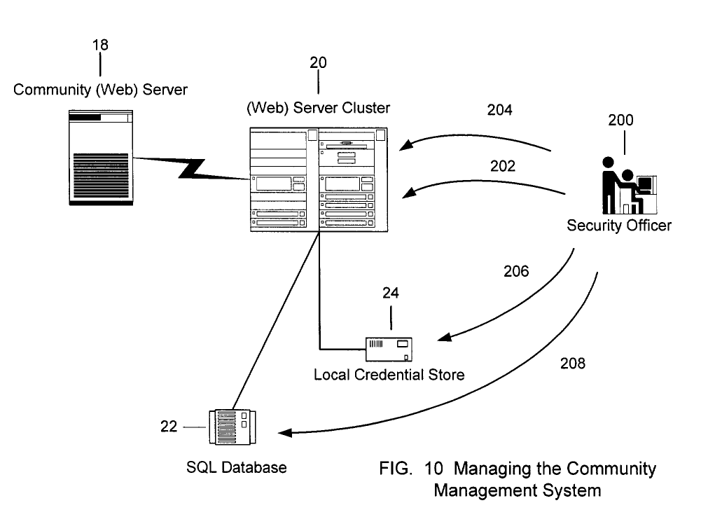

In a case where another CA were to become acceptable, implementation of a rule change could take the form of updating these two tables. However, not anyone would be authorized to make such changes. FIG. 10 illustrates process by which an authorized security officer would implement a rule change. In an authentication step 202, the Security Officer 200 would access the (Web) Server Cluster 18 using his own credential. In a first update step 204, the Security Officer 200 would access the database management system of the (Web) Server Cluster 18. The database management system of the (Web) Server Cluster would recognize the security officer as a database administrator with associated database modification capability. The Security Officer 200 could then update the table of acceptable CA's. In a second update step 206, the Security Officer 200 would instruct the Local Credential Store 24 to load the credential of the newly-authorized CA, and to set the status of the credential. (The Security Officer 200 might separately authenticate to the Local Credential Store 24.) In a logging step 208, the actions of the Security Officer 200 to implement the rule change would be recorded. In this way, the database administration functions can be used to implement community management functions.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

We claim:

1. A system for facilitating reliance among members of a community, each member having a private credential for use in a computing environment, each member obtaining the credential in accordance with a credential-issuance process, the system comprising:
(a) a database containing, for each member, at least one credential entry;
(b) a community management process with authority to sanction reliance by the community on credentials, such sanction authority being separate from the key-issuance process of the member; and
(c) a reliance rule set defining a scope of reliance the community may make on a member's credential.
